(19) United States
(12) Patent Application Publication
(10) Pub. No.: US 2020/0380556 A1
(43) Pub. Date: Dec. 3, 2020

(54) MULTITASK BEHAVIOR PREDICTION WITH CONTENT EMBEDDING

(71) Applicant: DOMO, Inc., American Fork, UT (US)

(72) Inventors: Ben Ainscough, Draper, UT (US); Porter Jenkins, Alpine, UT (US)

(21) Appl. No.: 16/889,790

(22) Filed: Jun. 1, 2020

Related U.S. Application Data
(60) Provisional application No. 62/854,970, filed on May 31, 2019.

(51) Int. Cl. G06Q 30/02; G06N 5/02

(52) U.S. Cl. CPC G06Q 30/0244; G06N 5/02

(57) ABSTRACT

The present disclosure describes aspects of multitask user behavior prediction with content embedding. Prediction logic receives sequential data encoding actions performed by users while traversing navigable content, such as webpages of a website. The actions can correspond to multiple possible actions that can be taken by users at and/or within respective web pages over a time sequence. The prediction logic can implement a machine-learned (ML) network trained to jointly model multiple, sequential user actions and simultaneously predict multiple user actions based on and/or in response to user action sequences.

### CROSS-REFERENCE TO RELATED APPLICATIONS

The present disclosure claims priority to U.S. Provisional Patent Application Ser. No. 62/854,970 filed May 31, 2019, the disclosure of which is incorporated by reference herein in its entirety.

### BACKGROUND

The data-rich environment of the Internet gives companies the ability to engage with greater numbers of potential customers through Internet-accessible web sites. Better understanding of user interaction with navigable content of these websites can lead to better website design and/or increased sales or other goals. Although attempts have been made to predict user actions in certain contexts, in many real-world situations, users are faced with many actions simultaneously, which can increase complexity and lead to poor results.

### BRIEF DESCRIPTION OF THE DRAWINGS

The details of one or more implementations for multitask user behavior prediction are set forth in the accompanying figures and the detailed description below.

FIG. 1 illustrates an example operating environment including an apparatus that can implement multitask behavior prediction with content embedding.

FIG. 2 illustrates an example apparatus for implementing multitask behavior prediction with content embedding.

FIG. 3 illustrates further examples of apparatus for implementing multitask behavior prediction with content embedding.

FIG. 4 illustrates additional LSTM aspects of multitask user behavior prediction.

FIG. 5 illustrates additional aspects of multitask user behavior prediction.

FIG. 6 illustrates with a flow diagram example methods for an apparatus to implement multitask behavior prediction with content embedding.

FIG. 7 illustrates with a flow diagram further example methods for an apparatus to implement multitask behavior prediction with content embedding.

### DETAILED DESCRIPTION

User interaction with navigable content, such as interconnected web pages of a website, can indicate a user's intent and purpose. Accurately modeling user interaction with navigable content may enable better site design, leading to increased user engagement. A content service, such as a website, platform, and/or the like, may utilize prediction logic that predicts future user actions to, inter alia, serve users with relevant content. Although these types of predictions may be capable of increasing content relevancy, in real-world settings, users are often faced with multiple potential actions simultaneously. As described in further detail herein, the disclosed prediction logic jointly models multiple, sequential user actions and can utilize such models to simultaneously predict multiple user interactions from sequential user interaction metadata (referred to also herein as user-interaction data streams, or istreams).

Consider, for example, a website that includes and/or is coupled to prediction logic configured to, inter alia, capture user interactions with navigable content of the website (e.g., webpages). The prediction logic may acquire istreams data that includes a sequence or stream of user actions captured as respective users traverse webpages of the website. The istream data may correspond to multiple potential actions available to users at respective webpages, such as “conversion actions,” duration of visits to the respective webpages, navigation to other webpages, and so on. As user herein, a “conversion” or “conversion action” refers to a desired or target user action, such as: user submission of a form, click-through, user engagement, user interaction with an engagement component (e.g., an instant messaging component), and/or the like.

The prediction logic uses istream data to, inter alia, model dependencies between multiple actions. For example, the time duration a user spends at a webpage may be indicative of the interest of the user in content of the webpage, which in turn informs how likely the user is to perform a conversion action. The prediction logic may also model how user actions evolve as users traverse respective paths through the navigable content of the website. By jointly modeling multiple, sequential user actions, the prediction logic can develop a multi-dimensional model of future user behavior that yields a better understanding of user intent and preferences, resulting in improved prediction performance for high-interest tasks (e.g., conversion actions). In the example above, accurate prediction of conversion actions may be used to adapt navigable content of the website to produce increased conversion rates.

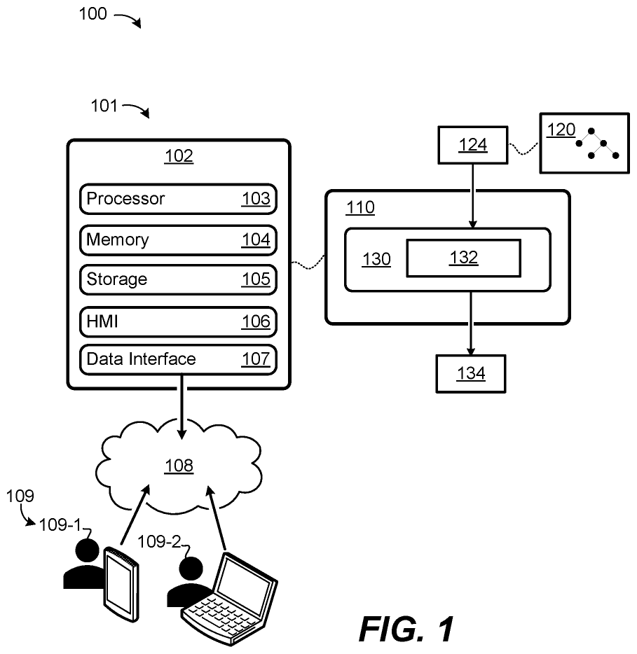

FIG. 1 illustrates an example operating environment 100 including an apparatus 101 that can implement multitask behavior prediction with content embedding, as disclosed herein. The apparatus 101 may include and/or be embodied by a computing system 102. The computing system 102 may be implemented and/or embodied by any suitable computing facility including, but not limited to: an electronic device, a host device, a computing device, a general-purpose computing device, an application-specific computing device, a server device, a content server, a web server, a computing cluster (e.g., a plurality of interconnected computing devices), a grid computing system, a distributed computing system, a cloud-based computing system, an embedded computing system, and/or the like.

The computing system 102 may include a processor 103, memory 104, non-transitory storage 105, a human-machine interface (HMI) component(s) 106, a data interface 107, and so on. The processor 103 may include any suitable processing component(s) including, but not limited to: a processor chip, processing circuitry, a processing unit, a central processing unit (CPU), a general-purpose processor, an application-specific integrated circuit (ASIC), programmable processing elements, a Field Programmable Gate Array (FPGA), and/or the like. The memory 104 may include any suitable memory component(s) and/or device(s) including, but not limited to: volatile memory, non-volatile memory, random access memory (RAM), dynamic RAM (DRAM), synchronous DRAM (SDRAM), cache memory, and/or the like. The non-transitory storage 105 may include any suitable non-transitory, persistent, and/or non-volatile storage component(s) and/or device(s) including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like. The HMI components 106 may include, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like. The data interface 107 may include any suitable data and/or communication component(s), interface(s) and/or device(s), including, but not limited to: I/O ports, I/O interconnects, I/O interfaces, communication ports, communication interconnects, communication interfaces, network ports, network interconnects, network interfaces, and/or the like.

The data interface 107 may couple the computing system 102 to a network 108. The network 108 may include any suitable electronic communication network(s) and/or combination of networks, including, but not limited to: wired networks, wireless networks, a local area network (LAN), a wide area network (WAN), a virtual private network (VPN), Internet Protocol (IP) networks, Transmission Control Protocol/Internet Protocol (TCP/IP) networks, the Internet, and/or the like. The data interface 107 may be further configured to couple the computing system 102 to users 109 through and/or by use of respective user devices, such as client computing devices, user computing devices, mobile computing devices, mobile communication devices, smartphones, and/or the like. In the FIG. 1 example, a first user 109-1 accesses the computing system 102 using a smartphone and a second user 109-2 accesses the computing system 102 using a desktop or laptop computing device. Alternatively, or in addition, users 109 may access the computing system 102 through HMI component(s) 106, as disclosed herein.

The computing system 102 may include, implement, and/or be coupled to prediction logic 110. In some implementations, portions of the prediction logic 110 (and/or one or more component(s) thereof) are implemented by use of resources of the computing system 102. Portions of the prediction logic 110 can be configured to operate on and/or by use of the processor 103 of the computing system 102, utilize memory 104 of the computing device 102, and so on. Portions of the prediction logic 110 may be implemented and/or realized by executable instructions maintained within a non-transitory storage medium, such as, for example, the non-transitory storage 106 of the computing system 102. Alternatively, or in addition, portions of the prediction logic 110 may be implemented and/or realized by hardware components, such as application-specific processing hardware, an application-specific integrated circuit (ASIC), FPGA, dedicated memory resources, and/or the like.

The prediction logic 110 can be configured to jointly model multiple, sequential user actions pertaining to navigable content 120, such as a website or the like. The navigable content 120 may be hosted by the computing system 102 and users 109 may access and/or interact with the navigable content 120 through the network 108. Alternatively, or in addition, the navigable content 120 (and/or portions thereof) may be hosted by another network-accessible service or system, not illustrated in FIG. 1 to avoid obscuring details of the illustrated examples.

The prediction logic 110 receives istream data 124 that includes, inter alia, a sequence of user actions, each corresponding to a respective content item (i) of the navigable content 120 (e.g., a respective web page i) at a respective time or timestamp (t). The prediction logic 110 includes and/or is coupled to a multi-task machine-learning and/or machine-learned (ML) engine 130. The ML engine 130 includes and/or is coupled to an ML model 132 trained to simultaneously predict multiple user actions based on and/or in response to user interaction sequences, such as sequences of user actions encoded within the received istream data 124. As illustrated in FIG. 1, the ML model 132 produces prediction data 134 based on and/or in response to the istream data 124. The prediction data 134 may be configured to quantify probabilities respective possible next user actions in the sequence of user actions encoded within the istream data 124 of a plurality of possible actions and/or tasks. The prediction data 134 may include probability estimates of multiple user actions and/or tasks simultaneously. The prediction data 134 may, therefore, include and/or be referred to as multitask or multi-action prediction data 134. The prediction data 134 may be used to, inter alia, adapt the navigable content 120 to increase the likelihood that the user 109 will perform a target action during subsequent interaction with the navigable content 120, such as a conversion action.

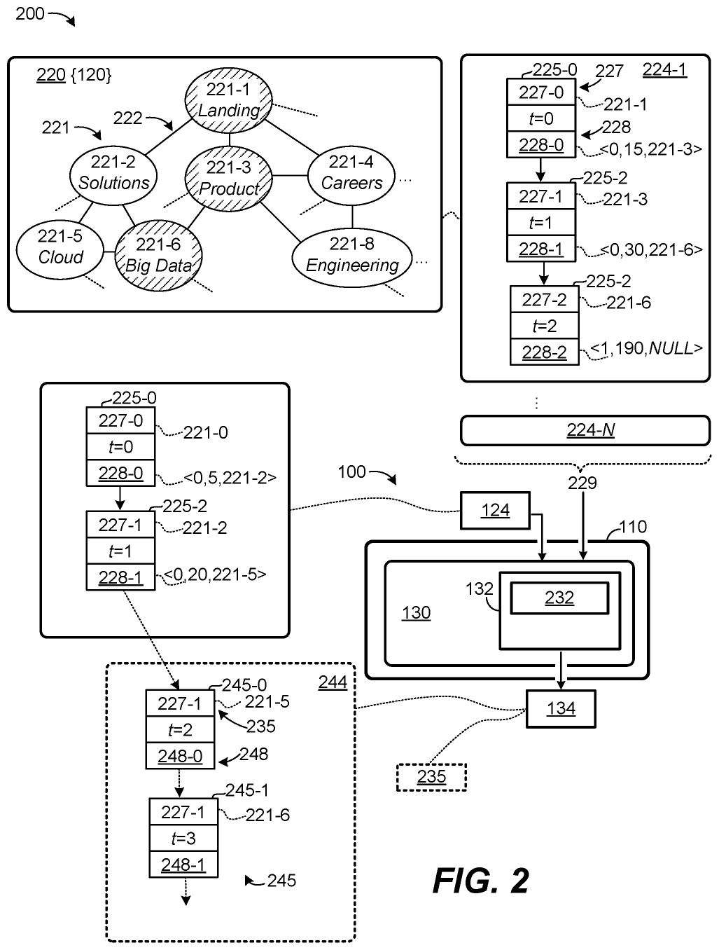

FIG. 2 illustrates further examples 200 of apparatus 100 for implementing multitask behavior prediction with content embedding, as disclosed herein. In the FIG. 2 example, the prediction logic 110 includes a machine-learning and/or ML engine 130, which may include and/or implement an ML architecture, such as a recurrent neural network (RNN) architecture, or the like. The ML engine 130 may implement an RNN deep learning model that takes istreams 124 (e.g., user action sequences) as input and outputs prediction data 134 (e.g., probabilities of future user actions of a set of multiple potential user actions).

The ML engine 130 device, train, refine, and/or otherwise maintain an ML model 132 that includes and/or is embodied by an RNN 232. The RNN 232 may be trained by use of a training dataset 229 that includes, inter alia, a plurality of istreams 124. Training istreams 224 may encode and/or be derived from istreams 124 (e.g., a sequence of actions captured during traversal of the navigable content 120 by respective users 109). FIG. 2 illustrates an example representation of navigable content 120. In the FIG. 2 example, the prediction logic 110 represents navigable content 120 using a graph data structure (graph 220) that includes nodes 221 connected by edges 222. Nodes 221 of the graph 220 represent content items of the navigable content 120 (respective webpages) and the edges 222 represent navigable links and/or references between the content items.

In the FIG. 2 example, the navigable content 120 pertains to an organization that offers data analytics products and/or services. The navigable content 120 includes a home or landing webpage (node 221-1) with links to webpages, including, but not limited to: a solutions webpage (node 221-2) with information pertaining to solutions offered by the organization, a product webpage (node 221-3) with information pertaining product offerings of the organization, a careers webpage (node 221-4), and so on. The nodes 221 of the graph 220 may be interconnected by edges 221 in accordance with links and/or references within the navigable content 120. In FIG. 2, the solutions webpage (node 221-2) is linked to a cloud webpage (node 221-5) and a big-data webpage (node 221-6), the product webpage (node 221-3) is linked to the big-data webpage (node 221-6), and an engineering webpage (node 221-8), the careers webpage (node 221-4) is also linked to the engineering webpage (node 221-8), and so on.

FIG. 2 further illustrates an exemplary training istream 224-1. The training istream 224-1 may have been observed and/or recorded during user traversal through the navigable content 120. The istream 224-1 may include a series of entries 225, each corresponding to user interaction with a respective webpage (i) at a respective time or timestamp (i). An entry 225 may include any suitable information pertaining to user interaction with a webpage, including an identifier 227, a time or timestamp, interaction metadata 228, and so on. The identifier 227 may be configured to specify the content item and/or webpage associated with the entry 225 using any suitable mechanism. In some examples, webpages may be identified by use of one-hot vectors. Alternatively, or in addition, the ML engine 130 may be configured to learn a representation that encodes similarity between webpages of the navigable content 120, as described in further detail herein. The interaction metadata 228 may specify respective actions by the user 109 of a plurality of potential user actions (e.g., actions corresponding to respective tasks of multiple tasks). The interaction metadata 228 indicate: whether the user 109 performed a conversion action at a specified webpage 221, the time duration spent by the user 109 at the specified webpage 221, the next webpage 221 visited by the user 109, and so on. In the FIG. 2 example, entries 225 of the training istream 224-1 are ordered sequentially by time and/or timestamp (from t=0 to t=2). In examples in which entries 225 are arranged in a time-based sequence, the entries 225 may omit explicit time and/or timestamp fields (since the sequential, time-based ordering of the entries 225 can be inferred from the arrangement of the entries 225).

In the FIG. 2 example, the training dataset 229 includes a training istream 224-1 that includes a sequence of entries 225-0 through 225-2, which represent sequential user actions at: a) the landing webpage (node 221-1 at t=0), b) the product webpage (node 221-3 at t=1), and c) the big-data webpage (node 221-6 at t=2), after which the user 109 leaves the website (navigable content 120). The interaction metadata 228 of the respective entries 225 indicate actions pertaining to multiple possible tasks at the specified webpages 221 and/or the specified times. The interaction metadata 228 may encode user actions as tuples including values corresponding to each action or task of multiple actions or tasks. In the FIG. 2 example, the interaction metadata 228 includes tuples, as follows <conversion action, duration, next>, indicating whether a conversion action was performed by the user 109 at the specified webpage, the duration the user 109 spent at the webpage, and a next webpage accessed by the user 109 (if any). The user metadata 228-0 of the training istream 224-1 may be encoded as a tuple <0, 15, 221-3>, indicating that no conversion action was performed at the landing webpage (node 221-1 at t=0), the user 109 spent 15 seconds at the landing webpage, and the user 109 subsequently navigated to the product webpage (node 221-3). The interaction metadata 228-1 of the next entry 225-1 of the training istream 224-1 may include <0, 30, 221-6>, indicating that the user 109 did not perform a conversion action during a 30 second visit to the product webpage (node 221-3 at t=1) and that the user 109 subsequently navigated to the big-data webpage 221-6. The interaction metadata 228-2 of the last entry 225-2 of the training istream 224-1 may include <1, 190, NULL>, indicating that the user 109 performed a conversion action during a 190 second visit to the big-data webpage (node 221-6 at t=2) and subsequently left the website. Other training istreams 224 of the training dataset 229 may encode similar multitask navigation data corresponding to other user sessions that may or may not result in conversion actions.

The ML engine 130 may be configured to train the RNN 232 to jointly model multiple, sequential user actions (as indicated by interaction data 228 of the training istreams 224). The RNN 232 may be trained using any suitable technique or mechanism. In one example, incoming users are observed while accessing the navigable content 120 (website) and istream data 124 are captured during respective navigation sessions. The istream data 124 may be captured over a plurality of different user sessions, times, operating conditions, and/or the like. The training dataset 229 may be formed and/or derived from the captured istream data 124. The training dataset 229 may, therefore, include a plurality of training istreams 224 each including and/or being derived from one or more captured istreams 124. The training dataset 229 may be split into three subsets, including a training set, a validation set, and test set. The training set may include about 80% of the training istreams 224 of the training dataset 229, and the validation and test sets may include about 10%, respectively. The training istreams 224 may be selected according to any suitable mechanism or criteria (e.g., may be randomly selected). The ML engine 130 may train the RNN 232 to replicate user actions of the training dataset 229 and may test and/or validate the trained RNN 232 by use of training istreams 224 of the test and/or validation sets. In some examples, the ML engine 130 trains the RNN 232 to implement a binary prediction and/or classification task. More specifically, to predict the probability that an istream 124 will result in a target action, such as a conversion action. Alternatively, the ML engine 130 may train the RNN 232 to predict subsequent user behavior, such as a sequence of future user actions that may or may not result in the user 109 performing a target action.

The ML engine 130 may utilize the trained RNN 232 to determine prediction data 134. The ML engine 130 receives live, real-world istream data 124, inputs the istream data 124 into the RNN 232, and causes the RNN 232 to produce corresponding prediction data 134. In some implementations, the prediction data 134 includes a probability that the user 109 associated with the istream data 124 will subsequently perform a target action, such as a conversion action (a target probability 135). Alternatively, or in addition, the prediction data 134 may predict one or more subsequent actions in the input istream 124 (istream predictions 244). The istream predictions 244 may be represented and/or quantified using any suitable mechanism. As illustrated in FIG. 2, in some examples, istream predictions 244 are represented by a series of one or more prediction entries 245, each corresponding to a future prediction action of the istream 124. The prediction entries 245 may include: respective identifiers 227 specifying the webpage (node 211) to which the predicted action pertains, times and/or time stamps, and prediction metadata 248, which may quantify a probability of the user 109 performing respective actions of a plurality of actions and/or tasks at the specified webpage. The prediction metadata 248 may include a tuple including values and/or probabilities for respective user actions, such as predicted values and/or probability that the user 109 will perform a conversion action at the specified webpage, probability that the user 109 will remain at the specified webpage for a predicted duration, a predicted next page, and so on. In some implementations, the RNN 232 produces a set number of prediction entries 245 and/or produces prediction entries 245 until probabilities of the prediction entries 245 no longer satisfy one or more thresholds.

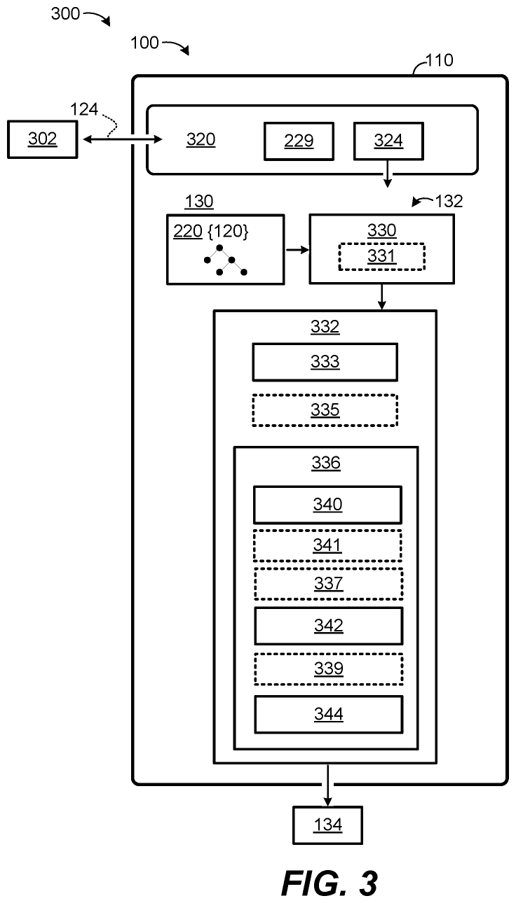

FIG. 3 illustrates further examples 300 of apparatus 100 for implementing multitask behavior prediction with content embedding. The ML engine 130 constructs and/or maintains a graph 220 configured to represent navigable content 120 of a website. In some implementations, the graph 220 ( [symbol] ) includes nodes 221 representing a set of webpages [symbol] ={p₁, p₂, . . . , pₘ} of the navigable content 120 (a website). Edges 222 of the graph 220, ϵ={e₁, e₂, . . . , e_{q}}, represent links and/or references between respective webpages. A given webpage (pᵢ) may be associated with a set of adjacent webpages, which can be encoded within an adjacency list of the webpage, [symbol] ᵢ={ [symbol] ₁, [symbol] ₂, . . . , [symbol] ₖ}, for webpage pᵢ.

The prediction logic 110 may include and/or be coupled to an agent 320 that monitors and/or captures istream data 124 pertaining to user navigation. The agent 320 may monitor interactions of users 109 at a content server 302, such as the computing system 102, an external content server or service, and/or the like. Alternatively, or in addition, the content server 302 can be configured to push istream data 124 to the prediction logic 110.

The ML engine 130 can use the istream data 124 to construct a dataset 229 to train the ML model 132 (a training dataset 229) and/or predict future actions of one or more users 109, as disclosed herein. The agent 320 may acquire information pertaining to navigation of the website by users 109, [symbol] ={u₁, u₂ . . . , uₙ}, including user actions, [symbol] ={Y_{1,1}, . . . , Y_{n,t}} performed by respective users 109 (uᵢ) at respective webpages (pᵢ) at respective times (t). The user actions may be maintained within entries 225 of the istream data 124. The entries 225 may be arranged in a time sequence. The entries 225 may include interaction metadata 228 specifying actions performed by a user 109 at specified webpages (pᵢ) at respective times (t) of a time sequence. The interaction metadata 228 may include tuples Y_{i,t}= [symbol] y_{i,t}, d_{i,t}, p_{i,t+1} [symbol] , where:
y_{i,t} is an indicator denoting whether the user 109 (uᵢ) performed a conversion action at webpage (i) at time (t), where y_{i,t}∈{0, 1}.
d_{i,t} indicates a time duration the user 109 (uᵢ) spends on page pᵢ, e.g., in seconds (d_{i,t}∈ [symbol] ⁺)
p_{i,t+1} is the next and/or future content item user 109 (uᵢ) will visit at time t+1 (p_{i,t+1}∈ [symbol] ᵢ)

The agent 320 may be further configured to capture a sequence of entries 225 pertaining to navigation of respective users 109, and arrange the entries 225 into istreams 124 for the respective users; e.g., a set of n istreams 124, S={s₁, s₂, . . . , sₙ}, each including a sequence of user actions performed while navigating through webpages of the website by a respective user 109.

The ML model 130 is configured to receive input istream data 324 asand produce probability estimates for multiple tasks (prediction data 134) by use of the ML model 132. The prediction data 134 may include a tuple of probabilities of future user actions [symbol] _{n,t+f}={Ŷ_{1,t+1}, . . . , Ŷ_{n,t+f}}, where Ŷ_{n,t+f}= [symbol] [symbol] (p_{i,t+f}), [symbol] (d_{i,t+f}), [symbol] (p_{i,t+f+1}) [symbol] and f denotes the number of future time periods predicted by the ML model 132. The prediction data 134 may include a plurality of conditional and/or joint probabilities for respective actions, each indicating a respective predicted value of the action and a corresponding probability. As disclosed in further detail herein, the prediction data 134 may include a conversion prediction 340 that may include a predicted value of a conversion action {0, 1} being performed on a specified webpage (pᵢ) at time (t) and a probability of the predicted conversion action, a duration prediction 342 that may include a predicted value for the duration the user 109 will remain at the specified webpage (pᵢ) at (t) and a corresponding probability, a next page prediction 344 that may include a predicted value for a next webpage visited by the user 109 and a probability of corresponding prediction, and so on.

In the FIG. 3 example, the prediction logic 110 receives istream input 324, which may include istream data 124 pertaining to a session of a given user 109, as follows, Sᵢ=((p_{i,1}, Y_{i,1}), . . . , (p_{i,t}, Y_{i,t})). At each time (t) the agent observes the webpage the user 109 traverses to (pᵢ) within the navigable content 120 and the set of actions taken Y_{i,t} by the user 109 (whether the user 109 performs a conversion action, time spent at the webpage (p_{i,t}), next webpage (p_{i,t+1}), and so on). The ML engine 130 can predict future actions of the user 109 (Ŷ_{i,t}) based on, inter alia, unseen and/or hidden data (e.g., data maintained within hidden layers and/or hidden state of the ML model 132).

In some implementations, webpages may be identified and/or represented by one-hot vectors having a same distance from one another; e.g., a same Euclidean distance (\sqrt{2}) from each other in [symbol] . At each time t, the ML engine 130 inputs a one-hot representation of p_{i,t}∈ [symbol] ^{|P|} (where the length of Sᵢ may vary from user 109 to user 109). The input p_{i,t}, however, may be extremely sparse and, as such, be a poor representation of relationships between webpages. More specifically, the one-hot representations may be incorporate webpage connectivity and/or adjacency lists in next page predictions 344. The ML engine 130 may improve prediction performance by, inter alia, including an embedding layer 330 configured to learn lower-dimensional webpage representations, which may obviate the need for inefficient, less accurate one-hot representations. The embedding layer 330 can learn lower dimensional webpage representations (embedding vector(s) 331) using any suitable technique. In the FIG. 3 example, the embedding layer 330 learns lower dimensional webpage representations (embedding vectors 331), e_{i,t}∈ [symbol] ^{δ} through linear mapping, as follows: e_{i,j}=W_{embed}P_{i,t}, where W_{embed}∈ [symbol] is a matrix of learnable parameters.

The lower dimensional webpage representations (embedding vectors 311) may be included in the input istream data 324 utilized within other layers of the ML engine 130. As disclosed herein, the embedding vectors 311 may enable the ML engine 130 to incorporate structural characteristics of the navigable content 120 (and/or graph 220) into the ML model 132.

In the FIG. 3 example, the ML engine 130 further includes a Long Short-Term Memory (LSTM) layer 332. The embedding vector 311 (e_{i,t}) is fed into an LSTM cell 333 of the LSTM layer 332. At each time step (t) the LSTM cell 333 updates a hidden state vector 333 (hₜ) based on the embedding vector e_{i,t} and previous hidden state 333 (hₜ₋₁), or an initial state at t=0 or 1. To manage long- and short-term dependencies, the ML model 132 can incorporate an input gate (inₜ), forget gate (fₜ), output gate (oₜ), and cell state vector (cₜ) in the updates of hₜ 333 generated by the LSTM cell 333. The LSTM cell 333 may, therefore, update the hidden state vector 335 (hₜ) as follows:

inₜ=a(Wᵢₙe_{i,j}+Zᵢₙhₜ₋₁+bᵢₙ)

fₜ=a(W_{f}eᵢₘ+Z_{f}hₜ₋₁+b_{f})

cₜ=fₜ·cₜ₋₁+inₜ·tanh(W_{c}e_{i,j}+Z_{c}hₜ₋₁+b_{c})

oₜ=a(Wₒe_{i,j}+Zₒhₜ₋₁+bₒ)

hₜ=oₜ·tanh(cₜ)

In the equations above, a(⋅) denotes a nonlinear activation function, tanh(⋅) represents a hyperbolic tangent, and Zⱼ, Wⱼ, bⱼ are learnable parameters, where j∈{inₜ, f_{y}, cₜ, oₜ}. The matrix Zⱼ is a mapping from the previous state hₜ₋₁ to j, Wⱼ learns the relationship of the embedding vector, and bⱼ is the bias term.

The hidden state vector 335 (hₜ) produced by the LSTM cell 333 may be provided to an output layer 336 of the ML model 132, which may be configured to predict actions y_{i,t}, dᵢₜ, and [symbol] _{i,t+1} (predictions 340, 342, and/or 344) based, at least in part, on the hidden state vector 333 hₜ and current interaction metadata 228-t. The output layer 336 may be configured to model the joint likelihood of a plurality of user actions using any suitable technique or mechanism. In the FIG. 3 example, the output layer 336 models the joint likelihood of respective actions using the chain rule of probability, as follows:

[symbol]

(y_{i,t},dᵢₜ,p_{i,t+1})= [symbol] (y_{i,t}|hₜ) [symbol] (dᵢₜ|y_{i,t}, hₜ) [symbol] (p_{i,t+1}|dᵢₜ, y_{i,t}, hₜ) Eq. 1

The conditional probabilities may include a conversion prediction 340, including a prediction that the user 109 will subsequently perform a conversion action (0 or 1) and/or a probability thereof, which may be obtained as follows:

[symbol]

( [symbol] _{i,t}|hₜ)=σ(W_{form}htₜ+b_{form}) Eq. 2

In Eq. 2, σ(⋅) is the sigmoid function. The resulting estimate of [symbol] _{i,t} may be used to determine predictions for other actions, such as a duration prediction 342 [symbol] (dᵢₜ), a next webpage prediction 344 [symbol] ( [symbol] _{i,t+1}), and so on, per Eq. 1.

To improve prediction of other tasks, the ML engine 130 can embed the conversion prediction 340 into a distributed representation (γ_{i,t}), γ_{i,t}∈ [symbol] . The distributed representation may eliminate the presence of a binary component of feature vector(s) when predicting other conditional probabilities, such as the duration prediction 342 (d_{i,t}), the next page prediction 344 (p_{i,t+1}) and so on. The ML engine 130 may encode dimensions of the conversion prediction 340 (γᵢₜ) to be

$$p ⌊ \frac{δ}{2} ⌋ .$$

The ML engine 130 may produce a distributed representation of the conversion prediction 340 as an embedded vector, or embedded conversion prediction vector 341 (γ_{i,t}), γ_{i,t}=Ω, where Ω∈ [symbol] is a maxtrix of learnable parameters and [symbol] ᵢₜ∈ [symbol] ^{2×1} is the vector of conversion predictions 340.

The embedded conversion prediction vector 341 is concatenated with the hidden state variable 335 (hₜ) to produce a feature vector 337 for regression of the duration prediction 344, as follows

$${β}_{t} = [ \begin{matrix}{γ}_{t} \\ {h}_{t}\end{matrix} ] .$$

A gaussian distribution with mean μ and unit variance may be assumed for [symbol] (d_{i,t}), such that [symbol] (dᵢₜ| [symbol] _{i,t}, hₜ)˜ [symbol] (μ,1), where μ= [symbol] _{duration}^{T}βₜ+b_{duration}. The ML engine 130 can be further configured to generate duration prediction(s) 342 for \hat{d}_{i,t} from the dot product of the weight and feature vectors for page duration, as follows, \hat{d}_{i,t}= [symbol] _{duration}^{T}βₜ+b_{duration.}

The ML engine 130 may then concatenate the normalized duration prediction 342 (\hat{d}_{i,t}) with the embedded conversion prediction vector 341 (ŷ_{i,t}) to obtain a feature vector 339 (πₜ) for use in generating the next page prediction 344,

$${π}_{t} = [ \begin{matrix}{γ}_{t} \\ {\hat{d}}_{i , t}\end{matrix} ] .$$

The ML engine may calculate a softmax of the feature vector 339 and weight matrix over the adjacency matrix of the current webpage (pᵢ) with a softmax adjacency function: p_{i,t+1}=softmax_{adj}(W_{page}πₜ+b_{page}) where

$${( soft max )}_{a d j} ( {x}_{i} ) = \frac{{e}^{{x}_{i}}}{{Σ}_{k ∈ {𝒜}_{i}} {e}^{{x}_{i}}} ,$$

where [symbol] ᵢ is the adjacency list for the webpage (pᵢ). The ML engine 130 may, therefore, encode structure of the graph 220 (navigable content 120) into the sequential predictive ML model 132.

The ML engine 130 can iteratively generate hidden state vectors (hₜ) 335 and corresponding predictions 340, 342, and 344 for time-sequence of entries 225 included in the input istream 325 (each entry 225 corresponding to a respective time of the time sequence from t=0 or 1 to 7). The hidden state vectors 335 (hₜ) for respective times t of the time sequence may incorporate hidden state vectors 335 (hₜ₋₁) of previous times t−1 of the time sequence. In some implementations, predictions 340, 342, and/or 344 generated in response to the entry 225 corresponding to the last time of the time sequence included in the input istream 324 are incorporated into the prediction data 134 output by the ML engine 130.

As disclosed herein, the ML engine 130 can be configured to train the ML model 132 using, inter alia, a training dataset 229 that includes a plurality of training istream data 224. The ML model 132 may be trained to maximize the probability of the conditional likelihood for the multiple actions (conversion action, duration, and next page), as follows:

$$ℒ = {{\prod }^{N}}_{i = 1} {{\prod }^{T}}_{t = 1} 𝒫 ( {𝓎}_{i , t} \vert {h}_{t} ) 𝒫 ( {d}_{i , t} \vert {𝓎}_{i , t} , {h}_{t} ) 𝒫 ( {𝓅}_{i , t + 1} \vert {d}_{i , t} , {𝓎}_{i , t} , {h}_{t} )$$

To facilitate training, the ML engine 130 may be configured to minimize the negative log likelihood and suppress the negative on the left-hand (for notational purposes below). The ML engine 130 may also insert a tuning parameter λ=[λ₁,λ₂,λ₃] to control the contribution of each task to the overall loss, as follows:

$$ℒ = - {{\prod }^{N}}_{i = 1} {{\prod }^{T}}_{t = 1} {λ}_{1} 𝒫 ( {𝓎}_{i , t} \vert {h}_{t} ) + {λ}_{2} 𝒫 ( {d}_{i , t} \vert {𝓎}_{i , t} , {h}_{t} ) + {λ}_{3} 𝒫 ( {𝓅}_{i , t + 1} \vert {d}_{i , t} , {𝓎}_{i , t} , {h}_{t} )$$

The ML engine 130 can employ cross-entropy loss for [symbol] (y_{i,t}) and [symbol] (p_{i,t+1}), and mean squared error loss for [symbol] (dᵢₜ), to minimize the expression above. In some implements, the ML engine 130 incorporates an L2 penalty over the weights for p_{i,t+1}, which may be controlled by a hyperparameter (α). These additional terms act to regulate the next page prediction task and, in turn, improve generalization performance, as follows:

$$ℒ = - {\sum }_{i = 1}^{N} {\sum }_{t = 1}^{T} \{ \begin{matrix}{λ}_{1} ( {y}_{i t} log 𝒫 ( {y}_{i , t} ) + ( 1 - {y}_{i t} ) log ( 1 - 𝒫 ( {y}_{i , t} ) ) ) + \\ \frac{{λ}_{2}}{2} {( {\hat{d}}_{i , t} - {d}_{i , t} )}^{2} + \\ {λ}_{3} log 𝒫 ( {p}_{i , t + 1} )\end{matrix} \} + \frac{α}{2} {‖ {𝒲}_{p a g e} ‖}_{2}^{2}$$

Training the ML model 132 may include iteratively applying training istream data 224, evaluating errors between prediction data 134 produced by the ML model 132 and actual user actions of the training istreams 224, and adjusting, refining, and/or optimizing weights of the embedding layer 330, LSTM layer 332, and/or LSTM cell(s) 333 accordingly.

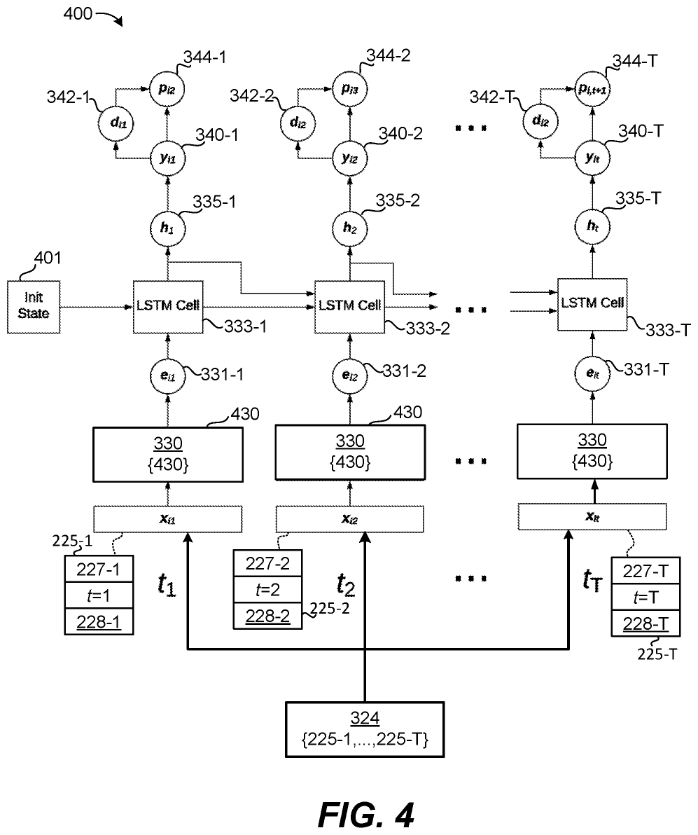

FIG. 4 illustrates an exemplary computational graph 400 of the ML model 132 of FIG. 3 over time. At t₁, the ML engine 130 processes a first entry 225 of an input istream 324, including interaction metadata 228-1 pertaining to actions of a user 109 at a specified webpage pᵢ at t=1. The ML engine 130 user an embedding matrix 430 (embedding layer 330) to produce an embedded vector 331-1 corresponding to the webpage (and/or graph 220 corresponding to the navigable content 120). The embedded vector 331-1 is input to the LSTM cell 311 (or a first instance of the LSTM cell 333-1), which determines a hidden state hₜ 335-1 for t=1 based on the entry 225-1 (interaction metadata 228-1) and an initial state 401, which may be a default or baseline state. The hidden state h₁ 335-1 and embedded vector 331-1 are then used to determine predictions for t=1, including a conversion prediction 340-1, a duration prediction 342-1, a next page prediction 344-1, and so on, as disclosed herein.

The hidden state h₁ 335-1 determined for the first time in the sequence t=1 may be used to determine the hidden state 335-2 (h₂) and/or predictions for the next entry 225-2 in the time sequence (t=2). Evaluation of the next entry 225-2 of the input istream 324 (t=2) may include determining an embedded vector 331-2, hidden state vector (h₂) 335-2 (by a second instance of the LSTM cell 333-2), a conversion prediction 340-2, a duration prediction 342-2, a next page prediction 344-2, and so on. A last instance of the LSTM cell 333-T may produce a last hidden state vector 335-T (h_{T}) from the hidden state vector (h_{T-1}) 335-T−1 of the next-to- lasttime of the sequence and the embedded vector 331-T generated from the last entry 225-T. The hidden state vector 335-T (h_{T}) may be used to generate a conversion prediction 340-T, duration prediction 342-T, and next page prediction 344-2 for t=T, and so on. The predictions 340, 342, and/or 344 determined for the last time of the time sequence may be incorporated into the prediction data 134 output by the ML engine 130 in response to the input istream data 324.

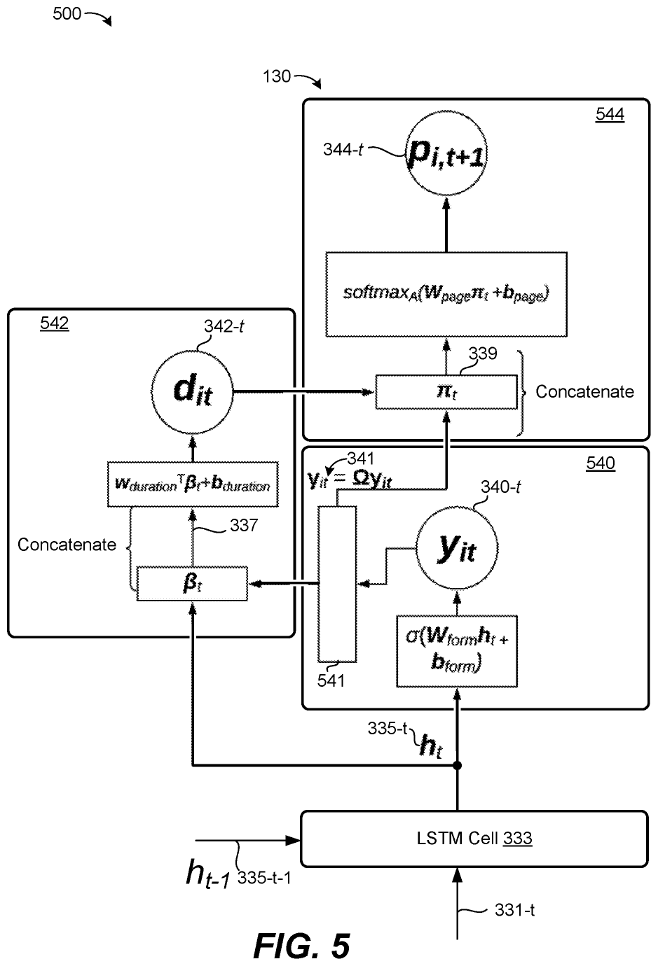

FIG. 5 illustrates an exemplary architecture 500 of an ML engine 130 for multitask behavior prediction. As illustrated, the LSTM cell 333 of the ML model 132 is configured to generate a hidden state vector 335-t (hₜ) for a current time t of the time sequence based on, inter alia, a hidden state vector 335-t−1 (hₜ₋₁) determined from the adjacent preceding time in the time sequence, and an embedded vector 331-t derived from interaction metadata 228-1 (and/or an entry 225-t). The ML engine 130 may further include and/or be coupled to conversion prediction logic 540 configured to derive a conversion prediction 340-t from the hidden state vector 335-t (hₜ). The conversion prediction logic 540 may be further configured to generate an embedded conversion prediction vector 341 corresponding to the conversion prediction 340-t (e.g., using distribution logic 541 configured to produce embedded conversion prediction vectors 341, γ_{i,t}=Ω, where Ω∈ [symbol] is a matrix of learnable parameters and [symbol] ᵢₜ∈ [symbol] ^{2×1} is the vector of conversion predictions 340).

The ML engine 130 further includes and/or is coupled to duration prediction logic 542 configured to derive duration predictions 342-t from feature vectors 337 produced by, inter alia, concatenating the hidden state vector (hₜ) 335-t with the embedded conversion prediction vector 341, as disclosed herein. Next page prediction logic 544 may be configured to generate feature vectors 339 by, inter alia, concatenating the hidden state vector (hₜ) 335-t with the embedded conversion prediction vector 341 and duration prediction 342-t, as disclosed herein.

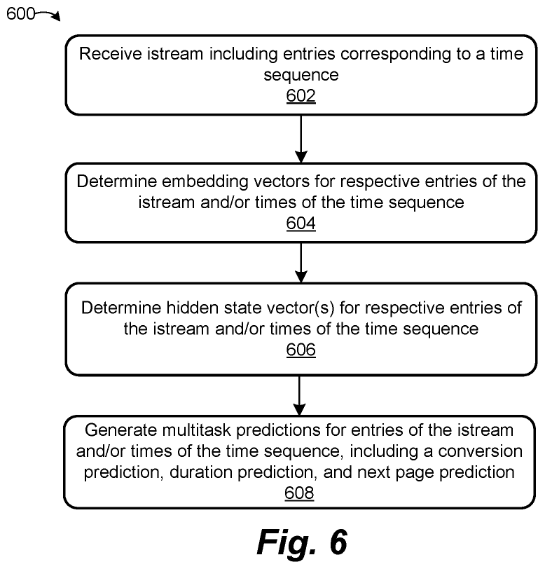

Example methods are described in this section with reference to the flow charts and flow diagrams of FIGS. 6 through 8. These descriptions reference components, entities, and other aspects depicted in FIGS. 1 through 5 by way of non-limiting example only.

FIG. 6 illustrates with a flow diagram 600 example methods for an apparatus to implement multitask behavior prediction with content embedding. The flow diagram 600 includes blocks 602 through 608. In some implementations, component system 102 and/or device can perform the operations of the flow diagram 600. Alternatively, one or more of the operations may be performed by hardware components, such as a processor, memory, ASIC, FPGA, and/or the like. At 602, prediction logic 110 receives istream data 124 including a plurality of entries 225. The entries 225 may be arranged in a time sequence from a first time t=1 to a last or current time t=T. The entries 225 may include information pertaining to user interaction with navigable content 120, such as webpages of a web site. The entries 225 may correspond to respective times and/or timestamps (t) of the time sequence (e.g., from an entry 225-1 corresponding to a first time t=1, to a last entry 225-T corresponding to a last time t=T of the time sequence). The istream data 124 may be received from a content server 402. Alternatively, or in addition, the istream data 124 may be captured by an agent 320 of the prediction logic 110.

At 604, an embedding layer 330 of the ML engine 130 determines embedding vectors 331 for respective entries 225 of the istream 224. The embedding layer 330 may be trained to learn lower dimensional webpage representations (embedding vectors 331 ), e_{i,t}∈ [symbol] ^{δ} through linear mapping, as follows: e_{i,j}=W_{embed}p_{i,t}, where W_{embed}∈ [symbol] is a matrix of learnable parameters. At 604, the embedding layer 330 may determine respective embedding vectors 3314 for respective times t of the time sequence represented by the istream 124 and/or entries 225-t of the istream 124.

At 606, the ML engine 130 generates hidden state vectors (hₜ) 335-t for respective times t (and/or corresponding entries 225-t) based on the embedded vectors 331-t generated at 604 and hidden state vectors (ht−1) 335-t-1 of previous times t−1 of the time sequence. The hidden state vectors (hₜ) 335-t may be generated by an LSTM cell 333 of an LSTM layer 332, as disclosed herein. At 606, the LSTM layer 332 may determine respective hidden state vectors 335-t for respective times t of the time sequence represented by the istream 124 and/or respective entries 225-t of the istream 124.

At 608, the ML engine 130 generates a plurality of predictions 340, 342, and 344, each corresponding to a respective task of a plurality of tasks and/or possible actions. The ML engine 130 may generate a conversion prediction 340-t, a duration prediction 342-t, and next page prediction 344-t. The conversion prediction 340-t may be generated by conversion prediction logic 540 of the ML engine 130, the duration prediction 342-t may be generated by duration prediction logic 542 of the ML engine 130, and the next page prediction 344 -t may be generated by next page prediction logic 544 of the ML engine 130, as disclosed herein. At 608, predictions 340-T, 342-T, and/or 344-T determined for a last time T of the time sequence (and/or a last entry 255-T of the istream 124) may be incorporated into prediction data 134 output in response to the istream 124.

In some implementations, 604, 606, and 608 may be implemented iteratively, with 604, 606, and 608 being implemented for the entry 225-1 (t=1), a next entry 225-2 in the time sequence (t=2), and so on, to the last entry 225-T (t=T) in the time sequence.

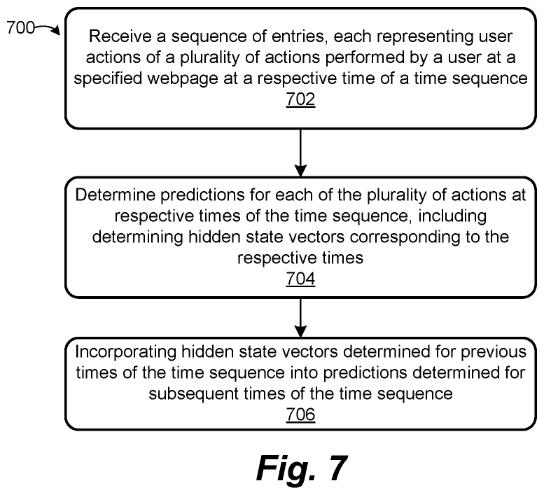

FIG. 7 illustrates with a flow diagram 700 further example methods for an apparatus to implement multitask behavior prediction with content embedding. At 702, prediction logic 110 receives a sequence of entries 225, each entry 225 representing user actions of a plurality of actions performed by a user at a specified webpage at a respective time of a time sequence. The entries 225 may be included in an istream 124 and/or input istream 324, as disclosed herein. The entries 225 may correspond to respective times of the time sequence. The entries may include a first entry 225-1 in the time sequence corresponding to t=1, a second entry 225-2 in the time sequence corresponding to t=2, and so on, including a last entry 225-T in the time sequence corresponding to t=T.

At 704, an ML engine 130 utilizes a trained ML model 132 to determine predictions for each of the plurality of actions at respective times of the time sequence, including determining hidden state vectors 335 corresponding to the respective times. The ML engine 130 may determine a conversion prediction 340, duration prediction 342, and next page prediction 344 for respective times of the time sequence (and/or respective entries 225).

At 706, the ML engine 130 incorporates hidden state vectors 335 determined for previous times of the time sequence (e.g., hidden state vectors (hₜ₋₁) 335-t−1 into predictions determined for subsequent times of the time sequence (e.g., hidden state vectors (hₜ) 335-t). Predictions determined for a last time T of the time sequence may be incorporated into prediction data 134 output in response to the sequence of entries 225.

In some implementations, methods 600 and/or 700 may further include using prediction data 134 to implement interventions to drive improved conversion rates. The prediction data 134 may identify paths through the navigable content 120 that are more likely to result in conversion actions. A content server 402 (and/or content manager) may utilize the prediction data 134 to adapt navigable content 120 to lead users 109 to paths corresponding to higher conversion rates (higher conversion predictions 340). Alternatively, or in addition, the content server 402 can use prediction data 134 produced in response to istream data 124 associated with a current user session to dynamically adapt the navigable content 120 to increase the likelihood that the user 109 will perform a conversion action (e.g., modify design and/or content of one or more webpages, and/or the like).

Although the subject matter has been described in language specific to structural features and/or methodological operations, it is to be understood that the subject matter defined in the appended claims is not necessarily limited to the specific examples, features, or operations described herein, including orders in which they are performed. Moreover, although implementations for multitask behavior prediction with content encoding have been described in language specific to certain features and/or methods, the subject of the appended claims is not necessarily limited to the specific features or methods described. Rather, the specific features and methods are disclosed as example implementations for multitask behavior prediction with content encoding.

1. A method, comprising
receiving a sequence of entries, each entry representing user actions of a plurality of actions performed by a user at a specified webpage at a respective time of a time sequence;
determining predictions for each of the plurality of actions at respective times of the time sequence, including determining hidden state vectors corresponding to the respective times; and
incorporating hidden state vectors determined for previous times of the time sequence into predictions determined for subsequent times of the time sequence.
